(19) United States
(12) Patent Application Publication
(10) Pub. No.: US 2021/0347946 A1
(43) Pub. Date: Nov. 11, 2021

(54) COPOLYMER AND METHOD FOR MANUFACTURING THE SAME

(71) Applicant: INDUSTRIAL TECHNOLOGY RESEARCH INSTITUTE, Hsinchu (TW)

(72) Inventors: Hui-Min WANG, Hsinchu City (TW); Jiun-Jy CHEN, Toufen City (TW); Hung-Jen LIU, Hsinchu City (TW); Hsin-Ching KAO, Baoshan Township (TW)

(73) Assignee: INDUSTRIAL TECHNOLOGY RESEARCH INSTITUTE, Hsinchu (TW)

(21) Appl. No.: 17/216,868

(22) Filed: Mar. 30, 2021

Related U.S. Application Data
(60) Provisional application No. 63/022,729, filed on May 11, 2020.

(51) Int. Cl. C08G 69/28; C08L 77/06

(52) U.S. Cl. CPC C08G 69/28; C08L 77/06

(57) ABSTRACT

A method of forming a copolymer includes reacting

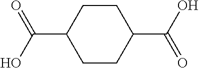 [SMILES: O=C(O)C1CCC(C(=O)O)CC1]

with

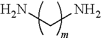

to form a salt. x parts by mole of the salt with y parts by mole of

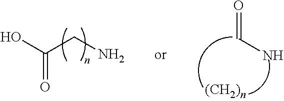

are reacted to form the copolymer having a chemical structure as

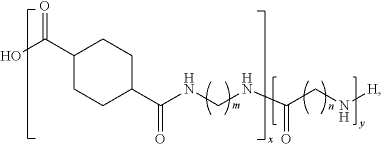

wherein m=4-10, n=4-6, and x:y=1:9 to 4:6. The copolymer may have a relative viscosity of 1.5 to 4.0.

### CROSS REFERENCE TO RELATED APPLICATIONS

This application claims the benefit of U.S. Provisional Application No. 63/022,729, filed on May 11, 2020, the entirety of which is/are incorporated by reference herein.

### TECHNICAL FIELD

The technical field relates to a copolymer and method of manufacturing the same.

### BACKGROUND

As consumer demand grows for products that are energy-saving and lightweight, the original metal materials used in many applications are gradually being replaced by engineering plastics. However, the outdoor applications of common commercially available nylon 6 and nylon 66 were limited due to their poor climate resistance and UV resistance. Accordingly, a novel polymer is called for to address the issue of poor climate resistance, insufficient strength, and the poor processability of nylon. In addition, development of a polymer process that can be performed at room temperature is needed.

### SUMMARY

One embodiment of the disclosure provides a copolymer, having a chemical structure of:

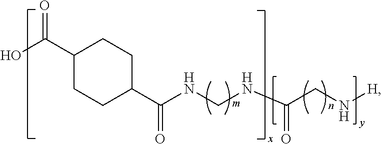

wherein m=4-10, n=4-6, and x:y=1:9 to 4:6.

In some embodiments, m=5-7 and n=5. In some embodiments, m=6 and n=5.

In some embodiments, the copolymer has a relative viscosity of 1.5 to 4.0.

One embodiment of the disclosure provides a method of forming a copolymer, including: reacting

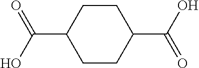 [SMILES: O=C(O)C1CCC(C(=O)O)CC1]

with

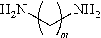

to form a salt; reacting x parts by mole of the salt with y parts by mole of

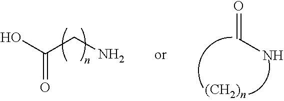

to form the copolymer having a chemical structure as

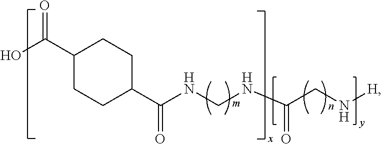

wherein m=4-10, n=4-6, and x:y=1:9 to 4:6.

In some embodiments, m=5-7 and n=5. In some embodiments, m=6 and n=5.

In some embodiments, the copolymer has a relative viscosity of 1.5 to 4.0.

In some embodiments, the salt has a chemical structure of

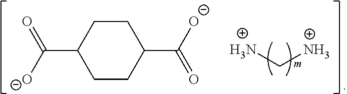

In some embodiments, the step of forming the salt is performed at a temperature of 25° C. to 100° C. under a pressure of 0.9 atm to 1.1 atm.

In some embodiments, the step of forming the copolymer is performed at a temperature of 250° C. to 290° C. under a pressure of 0.9 atm to 1.1 atm.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a method of forming a copolymer, including reacting

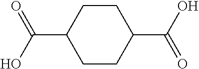 [SMILES: O=C(O)C1CCC(C(=O)O)CC1]

with

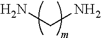

to form a salt. For example, the salt may have a chemical structure of

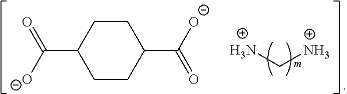

The diacid and the diamine may have a molar ratio of 0.9:1 to 1.2:1. If the diacid ratio is too high, it may form di(diacid)-diamine salt

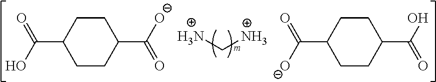

or tri(diacid)-di(diamine) salt

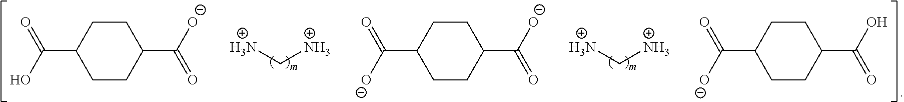

If the diamine ratio is too high, it may form diacid-di(diamine) salt

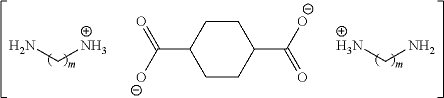

or di(diacid)-tri(diamine) salt

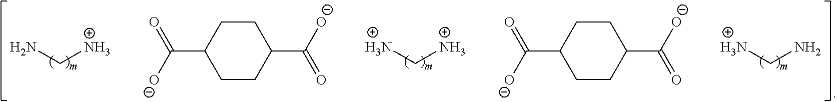

Subsequently, x parts by mole of the salt with y parts by mole of

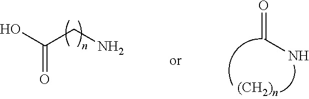

are reacted to form the copolymer having a chemical structure as

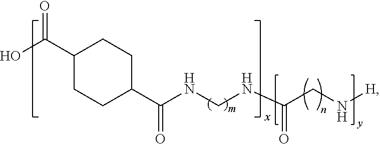

wherein m=4-10, n=4-6, and x:y=1:9 to 4:6. In some embodiments, m=5-7 and n=5. In some embodiments, m=6 and n=5. For example,

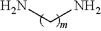

can be 1,6-hexanediamine,

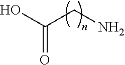

can be aminocaproic acid,

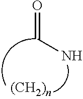

and can be caprolactam such as

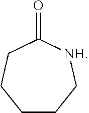

In some embodiments, the copolymer has a relative viscosity of 1.5 to 4.0. The relative viscosity of the copolymer is positively related to the weight average molecular weight of the copolymer. If the relative viscosity of the copolymer is too low or too high, the copolymer will be difficult to process and utilize.

In some embodiments, the step of forming the salt is performed at a temperature of 25° C. to 100° C. under a pressure of 0.9 atm to 1.1 atm. If the temperature of the step of forming the salt is too low, the reaction may not occur. If the temperature of the step of forming the salt is too high, the anion corresponding to the diacid and the cation corresponding to the diamine may have a molar ratio that is not 0.9:1 to 1.2:1.

In some embodiments, the step of forming the copolymer is performed at a temperature of 250° C. to 290° C. under a pressure of 0.9 atm to 1.1 atm. If the temperature of forming the copolymer is too low, the copolymer will not melt to polymerize. If the temperature of forming the copolymer is too high, the copolymer will crack during the melt polymerization. If the pressure of forming the copolymer is too low, the un-reacted substances will be easily vacuumed out, and the reactant ratio will be unbalanced, forming a copolymer with a low molecular weight. If the pressure of forming the copolymer is too high, the byproduct of the reaction (e.g. water) cannot be removed from the reaction, and the reaction interior temperature will be too low to polymerize a copolymer with a high molecular weight.

The copolymer can be used alone or blended with another polymer. In addition, the copolymer can be mixed with an inorganic material such as carbon material, silica, glass fiber, or another suitable inorganic material to form a composite material. The copolymer, the blend, or the composite material has excellent climate resistance, meaning it can be used in outdoor products.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

In following Examples, the relative viscosity of the copolymer was measured according the standard ASTM D789. The melting temperature (Tm), the glass transition temperature (Tg), and cold crystallization temperature (Tcc) of the copolymer were measured by differential scanning calorimetry (DSC). In addition, the tensile strength of the material was measured according to the standard ASTM D638.

### Example 1

5.2 g of 1,4-cyclohexanedimethanol (CHDM, 0.03 mol), 3.5 g of 1,6-hexanediamine (HMDA, 0.03 mol), and 20 mL of ethanol were added to a reaction bottle, and then heated to 50° C. and reacted at 50° C. for 8 hours. The reaction result was cooled to room temperature, and the solid thereof was then washed with methanol. The solid was then put into an oven at 80° C. to be dried, thereby obtaining white solid powder CHDA-HMDA. This product was determined by ¹H NMR, in which CHDA and HMDA had a molar ratio of 1:1. The reaction is shown below:

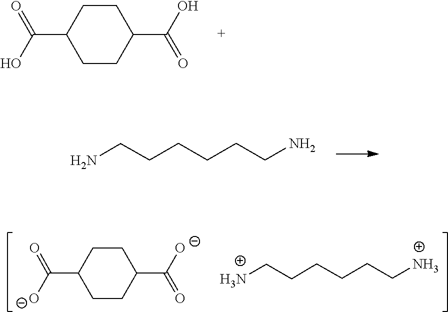

### Example 2

4.32 g of CHDA-HMDA (15 mmole) and 11.15 g of aminocaproic acid (ACA, 85 mmol) were placed under nitrogen, and heated to 250° C. and reacted at 250° C. for 3 hours. The reaction result was cooled to obtain Copolymer 1, which had a relative viscosity of 2.24, Tm of 188° C., Tg of 60° C., and Tcc of 135° C. The reaction is shown below:

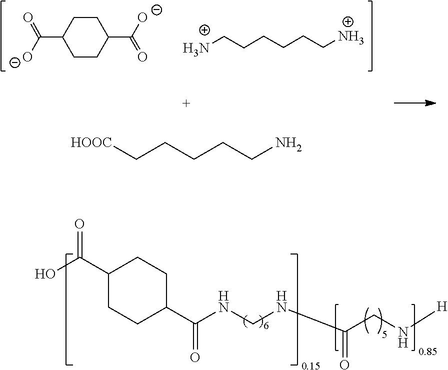

60 parts by weight of Copolymer 1 and 40 parts by weight of glass fiber (HP3540, commercially available from PFG Fiber Glass Corporation) were put into a screw to mix, and then thermally extruded to form a sheet. The sheet had a tensile strength of 175 MPa. After being placed in an environment with a temperature of 80° C., a relative humidity of 95%, and 500 ppm ozone for 7 days (equal to being placed outdoors for 20 years), the sheet had a tensile strength of 94 MPa. The tensile strength maintenance ratio of the sheet after the climate resistance test was 53.7%.

### Example 3

4.86 g of CHDA-HMDA (22.5 mmole) and 7.63 g of ACA (77.5 mmol) were placed under nitrogen, and heated to 250° C. and reacted at 250° C. for 3 hours. The reaction result was cooled to obtain Copolymer 2, which had a relative viscosity of 2.37, Tm of 220° C., Tg of 70° C., and Tcc of 170° C. The reaction is shown below:

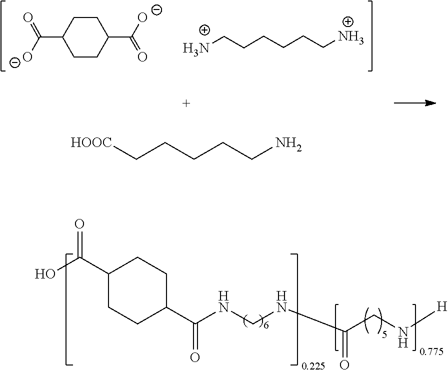

60 parts by weight of Copolymer 2 and 40 parts by weight of the glass fiber (HP3540) were put into a screw to mix, and then thermally extruded to form a sheet. The sheet had a tensile strength of 188 MPa. After being placed in an environment with a temperature of 80° C., a relative humidity of 95%, and 500 ppm ozone for 7 days (equal to being placed outdoors for 20 years), the sheet had a tensile strength of 103 MPa. The tensile strength maintenance ratio of the sheet after the climate resistance test was 54.8%.

### Example 4

8.65 g of CHDA-HMDA (30 mmole) and 9.18 g of ACA (70 mmol) were placed under nitrogen, and heated to 250° C. and reacted at 250° C. for 3 hours. The reaction result was cooled to obtain Copolymer 3, which had a relative viscosity of 2.50, Tm of 236° C., Tg of 79° C., and Tcc of 200° C. The reaction is shown below:

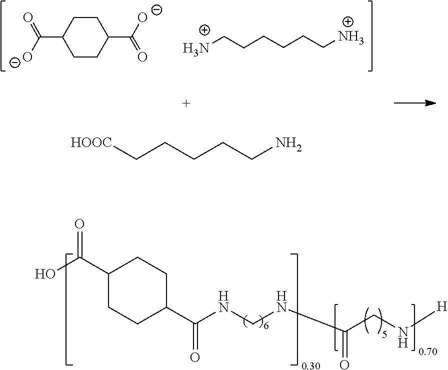

60 parts by weight of Copolymer 3 and 40 parts by weight of the glass fiber (HP3540) were put into a screw to mix, and then thermally extruded to form a sheet. The sheet had a tensile strength of 184 MPa. After being placed in an environment with a temperature of 80° C., a relative humidity of 95%, and 500 ppm ozone for 7 days (equal to being placed outdoors for 20 years), the sheet had a tensile strength of 108 MPa. The tensile strength maintenance ratio of the sheet after the climate resistance test was 57.7%.

### Comparative Example 1

1.44 g of CHDA-HMDA (5 mmole) and 12.5 g of ACA (95 mmol) were placed under nitrogen, and heated to 250° C. and reacted at 250° C. for 3 hours. The reaction result was cooled to obtain Copolymer 4, which had a relative viscosity of 2.60, Tm of 202° C., Tg of 45° C., and Tcc of 140° C. . The reaction is shown below:

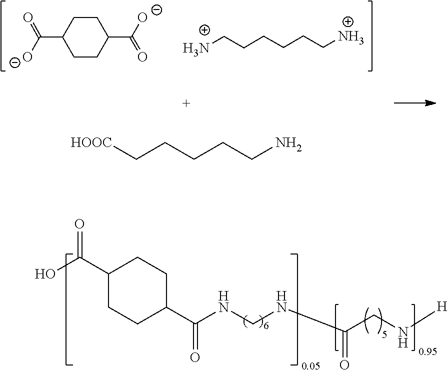

60 parts by weight of Copolymer 4 and 40 parts by weight of the glass fiber (HP3540) were put into a screw to mix, and then thermally extruded to form a sheet. The sheet had a tensile strength of 120 MPa. After being placed in an environment with a temperature of 80° C., a relative humidity of 95%, and 500 ppm ozone for 7 days (equal to being placed outdoors for 20 years), the sheet had a tensile strength of 60 MPa. The tensile strength maintenance ratio of the sheet after the climate resistance test was 50.0%.

### Comparative Example 2

14.4 g of CHDA-HMDA (50 mmole) and 6.56 g of ACA (50 mmol) were placed under nitrogen, and heated to 250° C. and reacted at 250° C. for 3 hours. The reaction result was cooled to obtain Copolymer 5, which had a relative viscosity of 1.15 and Tg of 89° C. (Tm and Tcc could not be measured). The reaction is shown below:

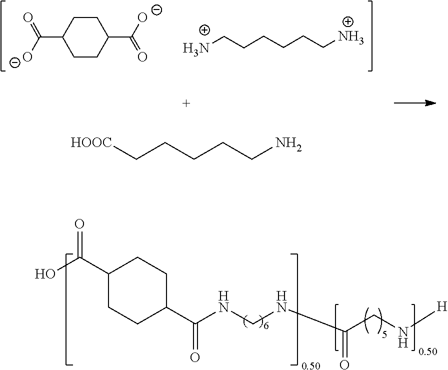

60 parts by weight of Copolymer 5 and 40 parts by weight of the glass fiber (HP3540) were put into a screw to mix, but could not be thermally extruded to form a sheet due to overly low molecular weight of Copolymer 5.

### Comparative Example 3

3.87g of CHDA (22.5 mmol), 2.61 g of HMDA (22.5 mmol), and 10.17 g of ACA (77.5 mmol) were placed under nitrogen, and heated to 250° C. and reacted at 250° C. for 3 hours. The reaction result was cooled to obtain Copolymer 6, which had a relative viscosity of 2.12, Tm of 217° C., Tg of 67° C., and Tcc of 170° C. The reaction is shown below:

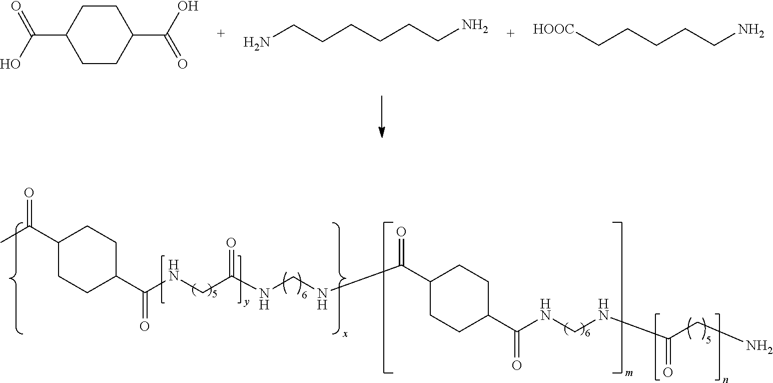

In the above formula, x+m=0.225, and xy+n=0.775. 60 parts by weight of Copolymer 6 and 40 parts by weight of the glass fiber (HP3540) were put into a screw to mix, and then thermally extruded to form a sheet. The sheet had a tensile strength of 145 MPa. After being placed in an environment with a temperature of 80° C., a relative humidity of 95%, and 500 ppm ozone for 7 days (equal to being placed outdoors for 20 years), the sheet had a tensile strength of 79 MPa. The tensile strength maintenance ratio of the sheet after the climate resistance test was 54.4%.

### Comparative Example 4

6.5 g of CHDA-HMDA (22.5 mmole) and 5.8 g of glycine (Gly, 77.5 mmol) were placed under nitrogen, and heated to 250° C. and reacted at 250° C. for 3 hours. The reaction result was cooled to obtain a cracked Copolymer 7, which had Tm of 247° C., decomposition temperature (Td) of 234° C., and Tg of 103° C. Because Td of Copolymer 7 is lower than Tm of Copolymer 7, Copolymer will be cracked during melting polymerization. The reaction is shown below:

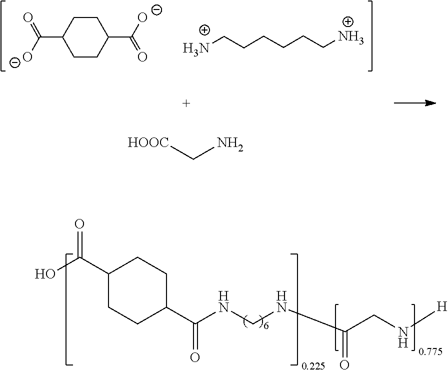

### Comparative Example 5

12.5g of ACA (95 mmol) was placed under nitrogen, and heated to 250° C. and reacted at 250° C. for 3 hours. The reaction result was cooled to obtain polymer, which had a relative viscosity of 2.60, Tm of 220° C., Tg of 45° C., and Tcc of 170° C. The reaction is shown below:

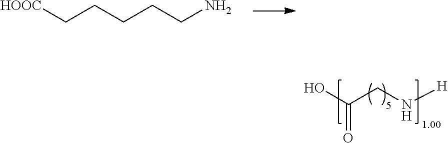

In the above formula, 1.00 means the ratio (100%) of the repeating unit rather than the repeating number of the repeating unit. 60 parts by weight of the polymer and 40 parts by weight of the glass fiber (HP3540) were put into a screw to mix, and then thermally extruded to form a sheet. The sheet had a tensile strength of 136 MPa. After being placed in an environment with a temperature of 80° C., a relative humidity of 95%, and 500 ppm ozone for 7 days (equal to being placed outdoors for 20 years), the sheet had a tensile strength of 66 MPa. The tensile strength maintenance ratio of the sheet after the climate resistance test was 48.5%.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A copolymer, having a chemical structure of: 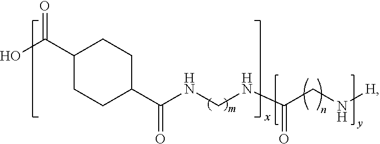
wherein m=4-10,
n=4-6, and
x:y=1:9 to 4:6.

2. The copolymer as claimed in claim 1, wherein m=5-7 and n=5.

3. The copolymer as claimed in claim 1, wherein m=6 and n=5.

4. The copolymer as claimed in claim 1, having a relative viscosity of 1.5 to

4. 0.

5. A method of forming a copolymer, comprising:
reacting 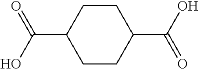 [SMILES: O=C(O)C1CCC(C(=O)O)CC1]
with 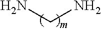
to form a salt;
reacting x parts by mole of the salt with y parts by mole of 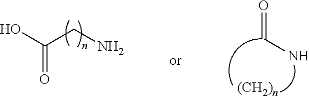
to form the copolymer having a chemical structure as 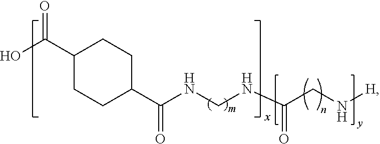
wherein m=4-10,
n=4-6, and
x:y=1:9 to 4:6.

6. The method as claimed in claim 5, wherein m=5-7 and n=5.

7. The method as claimed in claim 5, wherein the copolymer has a relative viscosity of 1.5 to 4.0.

8. The method as claimed in claim 5, wherein the salt has a chemical structure of

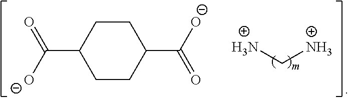

9. The method as claimed in claim 5, wherein the step of forming the salt is performed at a temperature of 25° C. to 100° C. under a pressure of 0.9 atm to 1.1 atm.

10. The method as claimed in claim 5, wherein the step of forming the copolymer is performed at a temperature of 250° C. to 290° C. under a pressure of 0.9 atm to 1.1 atm.
